(19) United States
(12) Patent Application Publication
(10) Pub. No.: US 2019/0278346 A1
(43) Pub. Date: Sep. 12, 2019

(54) CONTROLLING AND/OR MONITORING CATHODIC PROTECTION RECTIFIERS

(71) Applicant: Corrpro Companies, Inc., Medina, OH (US)

(72) Inventors: George H. Hayes, Chiefland, FL (US); Dale Lindemuth, Spring, TX (US); Clement A. Firlotte, Medina, OH (US); Michael M. Dockery, Sherwood Park (CA)

(21) Appl. No.: 16/297,038

(22) Filed: Mar. 8, 2019

Related U.S. Application Data
(60) Provisional application No. 62/640,929, filed on Mar. 9, 2018.

(51) Int. Cl. G06F 1/26; H02H 9/00; H02M 7/217

(52) U.S. Cl. CPC G06F 1/26; H02M 7/217; H02H 9/00

(57) ABSTRACT

Controlling electric power inputs to cathodic protection rectifiers and monitoring the rectifiers. A rectifier controller connects between the power source and the rectifier and adds remote control and monitoring features to the rectifier. In an aspect, the rectifier controller described herein enables a user to control the rectifier over the entire output range rather than merely at tap-step settings. In another aspect, the rectifier controller described herein enables remote monitoring and control of the rectifier.

### CROSS-REFERENCE TO RELATED APPLICATION

The present application claims the benefit of U.S. Provisional Application No. 62/640,929, filed Mar. 9, 2018, the entirety of which is hereby incorporated by reference.

### BACKGROUND

Aspects of the present disclosure generally relate to the field of controllers and monitors for impressed current cathodic protection (ICCP) rectifiers.

Many existing ICCP rectifiers do not have the capabilities required for modern operations. Replacing these existing rectifiers with modern rectifiers that may include upgraded capabilities is cost prohibitive and time consuming. Although these modern rectifiers may include upgraded capabilities, they utilize taps on the secondary winding to vary the rectifier output. This reliance on winding taps disadvantageously results in a coarse variance capability. In other words, conventional ICCP rectifiers, even more modern ones, are unable to provide control over the entire output range.

### SUMMARY

Aspects of the present disclosure include a rectifier controller configured to add remote control and monitoring features to existing ICCP rectifiers at a fraction of the cost of complete replacement. In an aspect, the rectifier controller described herein enables a user to control the rectifier over the entire output range rather than merely at tap-step settings. In another aspect, the rectifier controller described herein enables remote monitoring and control of the rectifier.

A controller embodying aspects of the disclosure includes a triode for alternating current (TRIAC) and an electric power output electrically coupled to the TRIAC. The TRIAC is electrically coupled to an alternating current (AC) electric power input and is configured to control a phase angle of received AC electrical power by switching into and out of conduction in response to a trigger signal at a predetermined phase of the received AC electrical power. The electric power output is configured to electrically connect to an input of a cathodic protection rectifier. Via this connection, the electric power output provides the phase angle controlled AC electrical power to the rectifier. The switching into and out of conduction by the TRIAC causes a voltage output and/or a current output of the rectifier to vary continuously from zero to full-scale output as a function of the controlled phase angle of the AC electrical power.

In one form, the controller includes a microcomputer that logs to memory values of a shunt output and/or a voltage output of the rectifier. In another form, the microcomputer provides the logged values to a remote user computing device. In yet another form, the microcomputer receives control signals from remote user computing devices that set up and/or calibrate the microcomputer for controlling the conduction modulation of the TRIAC.

A method embodying aspects of the present disclosure includes receiving AC electrical power from an electric power supply and receiving a trigger signal from a microcomputer. The method further includes controlling a phase angle of the received AC electrical power by switching a solid-state semiconductor device into and out of conduction in response to receiving the trigger signal at a predetermined phase of the received AC electrical power and providing the phase angle controlled AC electrical power via the semiconductor device to an input of a cathodic protection rectifier. Switching the semiconductor device into and out of conduction causes at least one of a voltage output of the cathodic protection rectifier and a current output of the cathodic protection rectifier to vary continuously from zero to a full-scale output thereof based on the controlled phase angle of the AC electrical power.

In yet another form, a system includes one or more user computing devices, a communications network, and at least one controller such as described above. The one or more user computing devices are communicatively coupled to the at least one controller via the communications network.

Other objects and features will be in part apparent and in part pointed out hereinafter.

### BRIEF DESCRIPTION OF THE DRAWINGS

FIG. 1 illustrates an exemplary rectifier controller and rectifier according to an embodiment.

FIG. 2 illustrates aspects of the exemplary rectifier controller of FIG. 1.

FIG. 3 is a block diagram schematic of an exemplary rectifier controller according to an embodiment.

FIG. 4 is a schematic of an exemplary triode for alternating current (TRIAC) driver board according to an embodiment.

FIG. 5 illustrates an exemplary triggering by pulse train synchronization according to an embodiment.

FIG. 6 illustrates an exemplary remote control and monitoring rectifier controller system according to an embodiment.

FIG. 7 is a block diagram of an exemplary computing device architecture within which aspects of the disclosure are implemented according to an embodiment.

Corresponding reference characters indicate corresponding parts throughout the drawings.

### DETAILED DESCRIPTION

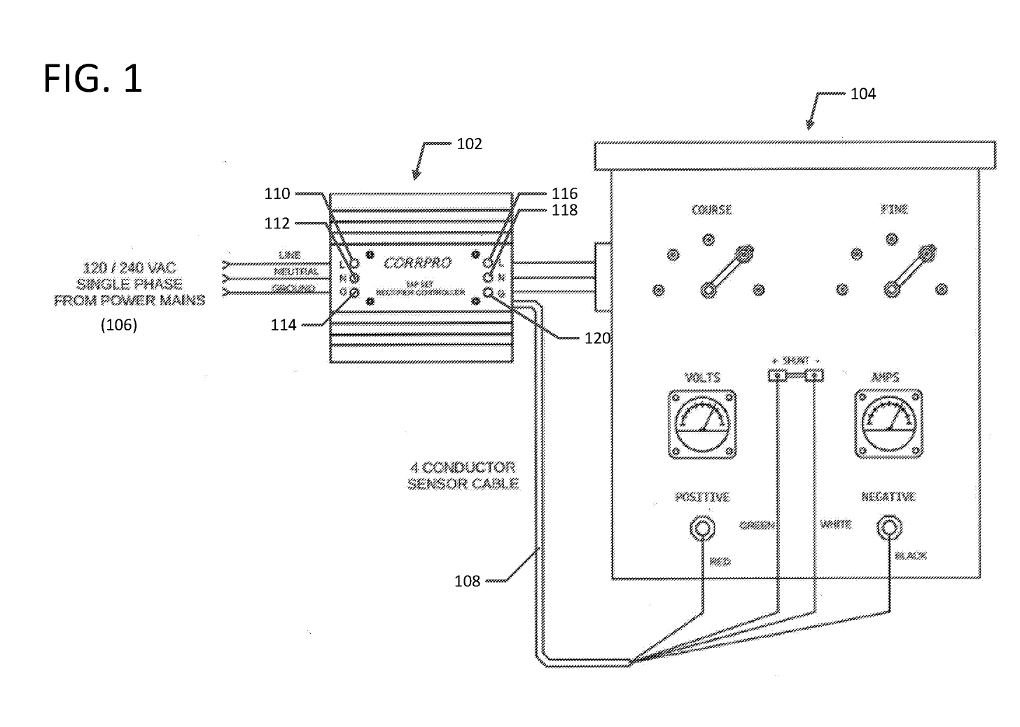

FIG. 1 illustrates an exemplary rectifier controller 102 and an exemplary rectifier 104. As illustrated, the rectifier controller 102 is electrically coupled between the rectifier 104 and a single-phase alternating current (AC) power source 106 (e.g., “power mains”). Additionally, rectifier controller 102 and rectifier 104 are electrically and/or communicatively coupled, such as via a sensor cable 108 (e.g., a four-conductor sensor cable, etc.). The rectifier controller 102 includes a line input 110, a neutral input 112, a ground input 114, a line output 116, a neutral output 118, and a ground output 120.

In an embodiment, rectifier controller 102 enables control of rectifier 104 over the entire output range (e.g., continuously) rather than merely at tap-step settings. Additionally or alternatively, rectifier controller 102 enables monitoring and/or controlling rectifier 104 remotely (e.g., via a computing device and communication network, etc.). In an aspect, rectifier 104 is installed on pipelines, above-ground and/or below-ground storage tanks (e.g., tank farms, storage facilities, etc.), and any like structures (e.g., those at power generating plants, gas stations, off-shore drill rigs, etc.) that utilize impressed current cathodic protection (ICCP). The rectifier controller 102 greatly reduces the man-hours required of owners and/or operators to maintain, monitor, and/or adjust rectifier 104. Furthermore, the enhanced reporting capabilities of the rectifier controller 102 enables operators of rectifier 104 to meet governmental reporting regulations, for example, faster and more cost effectively than conventional techniques.

In an aspect, rectifier controller 102 provides variable control of rectifier 104 (e.g., AC transformer type rectifiers, etc.). The rectifier controller 102 is electrically coupled between the rectifier AC input voltage from a power source (e.g., power mains) and the AC input to the rectifier 104. The rectifier controller 102 utilizes phase control of the AC line voltage to vary the output of rectifier 104 from zero to the full-scale output of the rectifier 104. In an embodiment, the rectifier output is controlled via a communication network (e.g., local area network (LAN), Internet, etc.), as further described herein. Aspects of the rectifier controller 102 provide one or more of the following operating modes when connected to rectifier 104 (e.g., a TAP set rectifier, etc.):
Precise, constant voltage regulation of the rectifier output;
Precise, constant current regulation of the rectifier output;
Data Logging of the rectifier outputs;
Remote control of the rectifier outputs via a communication network (e.g., Internet, etc.); and
Transmission of rectifier output parameters and/or stored data via a communication network (e.g., Internet, etc.).

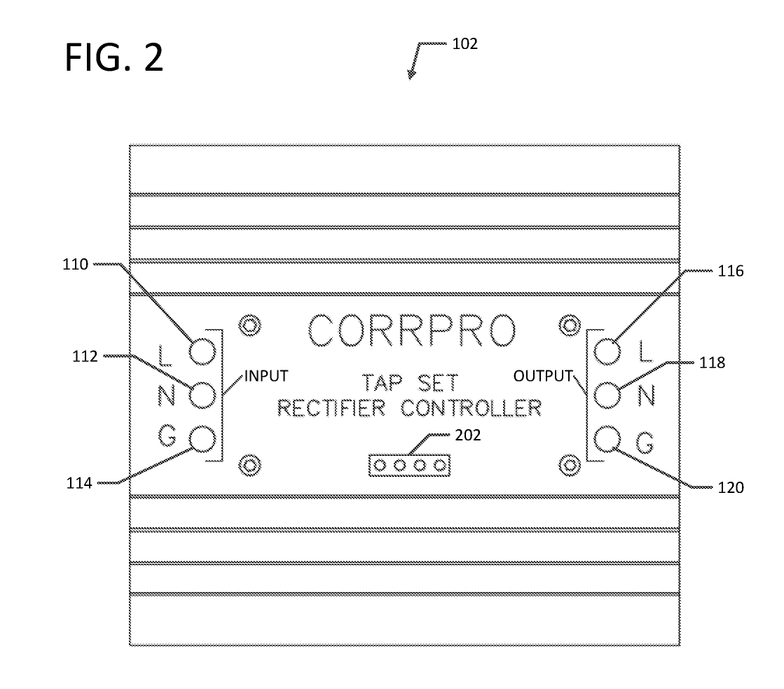

FIG. 2 illustrates a top view of an exemplary embodiment of rectifier controller 102. In addition to the line input 110, neutral input 112, ground input 114, line output 116, neutral output 118, and ground output 120, the rectifier controller 102 includes a network interface 202. The network interface 202 is configured to communicatively couple aspects of rectifier controller 102 (e.g., power supply, microcomputer, etc.) to a communications network (e.g., RS485 network, etc.), as further described herein.

In an embodiment, rectifier controller 102 includes a cover (e.g., sheet aluminum cover, etc.) configured to house and/or protect aspects of the controller from environmental elements. Electronic components of rectifier controller 102, as further described herein, are embodied within a printed circuit board (PCB).

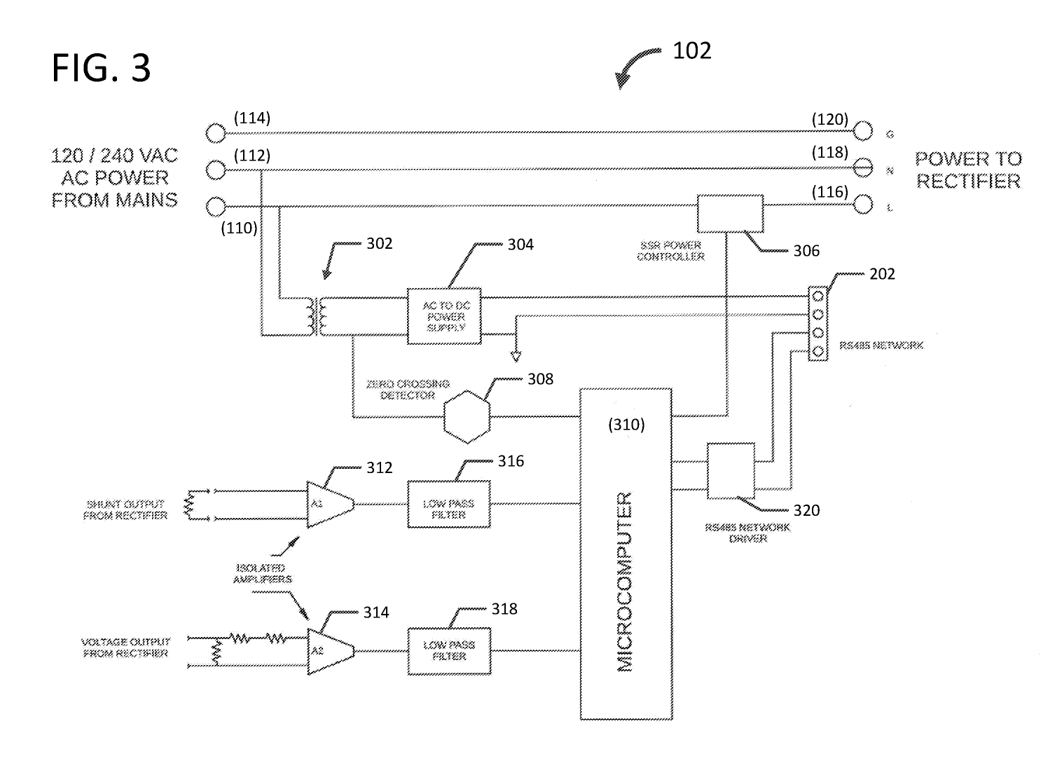

FIG. 3 is an exemplary simplified block diagram schematic of rectifier controller 102. In this embodiment, rectifier controller 102 includes a transformer 302, a power supply (e.g., AC to DC power supply) 304, a solid-state semiconductor device 306, a zero-crossing detector 308, a microcomputer 310, a first isolated amplifier 312, a second isolated amplifier 314, a first low-pass filter 316, a second low-pass filter 318, and a network driver 320. In an embodiment, the semiconductor device 306 is a triode for alternating current (TRIAC), which may also be referred to as a bidirectional triode thyristor and/or a bilateral triode thyristor.

The neutral input 112 (e.g., from power source 106) is electrically coupled to the neutral output 118 (e.g., to rectifier 104). The ground input 114 (e.g., from power source 106) is electrically coupled to the ground output 120 (e.g., to rectifier 104) via an electrical conductor (e.g., a wire, a metallic trace, etc.). A first (e.g., primary) winding of the transformer 302 is electrically coupled to the line input 110 and the neutral input 112. The power supply 304 and an input of the zero-crossing detector 308 are each electrically coupled to a second (e.g., secondary) winding of the transformer 302. An output of the zero-crossing detector 308 is electrically and/or communicatively coupled to the microcomputer 310. An input of semiconductor device 306 is electrically coupled to the line input 110 and an output of semiconductor device 306 is electrically coupled to the line output 116. Furthermore, semiconductor device 306 is electrically and/or communicatively coupled to the microcomputer 310.

One or more inputs of the first isolated amplifier 312 are electrically coupled to a shunt output from rectifier 104, and an output of the first isolated amplifier 312 is electrically and/or communicatively coupled to an input of the first low-pass filter 316. An output of the first low-pass filter 316 is electrically and/or communicatively coupled to the microcomputer 310. One or more inputs of the second isolated amplifier 314 are electrically coupled to a voltage output from rectifier 104, and an output of the second isolated amplifier 314 is electrically and/or communicatively coupled to an input of the second low-pass filter 318. An output of the second low-pass filter 318 is electrically and/or communicatively coupled to the microcomputer 310.

The network driver 320 is electrically and/or communicatively coupled between the network interface 202 and the microcomputer 310. The power supply 304 is electrically and/or communicatively coupled to the network interface 202.

The rectifier controller 102 is connected between the power source 106 (e.g., AC Power Mains) and the rectifier 104 (e.g., rectifier AC input power). In addition, a sensor cable 108 (e.g., 4-conductor sensor cable) is connected to the rectifier outputs and a standard rectifier shunt.

The isolated amplifiers 312 and 314 (e.g., Amplifiers A1 and A2) are high-voltage isolated input amplifiers. Exemplary isolated amplifiers include AMC1301-Q1 amplifiers available from Texas Instruments. The isolated amplifiers 312 and 314 connect to the rectifier outputs (shunt and voltage, respectively) and provide a DC output voltage which corresponds to the rectifier voltage output and current. These signals from each isolated amplifier 312 and 314 are applied to a low pass filter (low-pass filters 316 and 318, respectively) to remove a low frequency component (e.g., 6 Hz) and then applied to analog-to-digital inputs of the microcomputer 310. This allows the microcomputer 310 to measure these parameters for control and/or logging purposes. In an embodiment, the isolated amplifiers 312 and 314 enable microcomputer 310 to read a small (e.g., on the scale of millivolts, etc.) shunt signal that is on top of a large (e.g., on the scale of 100 Volts, etc.) pulsing waveform.

The AC input power from the mains is applied to transformer 302 to provide DC power for the electronic components of rectifier controller 102 (e.g., semiconductor device 306, zero-crossing detector 308, microcomputer 310, network interface 202, etc.) and a 60 Hz reference signal for zero crossing detection by zero-crossing detector 308. The output of the zero-crossing detector 308 is a pulse that occurs when the AC input waveform crosses the zero voltage axis. This output signal of the zero-crossing detector 308 is used by the microcomputer 310 for timing the phase control switching described herein.

The AC power is supplied to semiconductor device 306 that is switched OFF and ON by a trigger signal from the microcomputer 310. In an embodiment, semiconductor device 306 is a high-current Silicon Controlled Rectifier (SCR). To control the power output to the rectifier 104, the microcomputer 310 allows a portion of the AC waveform to reach the rectifier 104. When the AC waveform crosses the zero point on the voltage axis, the microcomputer 310 begins timing a delay before generating the trigger signal to switch on semiconductor device 306 (e.g., SCR switch). The longer the delay time before switching ON the semiconductor device 306, the less of the AC waveform is applied to the rectifier 104 input and the rectifier 104 output is lower. Shorter delay times result in more of the AC waveform applied to the rectifier 104, resulting in higher rectifier output. The switching ON and OFF (e.g., into and out of conduction) of semiconductor device 306 in this manner controls the phase angle of the AC waveform that reaches rectifier 104. In an embodiment, this procedure is known as phase angle control. Accordingly, this switching of semiconductor device 306 enables rectifier controller 102 to cause an output (e.g., voltage output, current output, etc.) of the rectifier 104 to vary continuously from zero to a full-scale output as a function of the controlled phase angle of the AC waveform. This ability of rectifier controller 102 to vary the output of rectifier 104 from zero to the full-scale output is in contrast to conventional techniques that permit controlling the rectifier output only at tap-step settings. The semiconductor device 306 is configured to resist false triggering, in accordance with an embodiment of the disclosure. In one or more embodiments, the phase angle control may alternatively be provided by one or more of a TRIAC, a thyristor, a silicon controlled rectifier (SCR), a thyratron, or similar gated diode-like devices.

The microcomputer 310 communicates with a user computing device (e.g., used by an operator) via the network interface 202 and a communication network, as further described herein. In an embodiment, the communication network is a two-wire RS485 network. Via the user computing device and communication network, the operator enters the desired values of voltage and current for the output of rectifier 104. The microcomputer 310 continuously measures the rectifier output and slowly increases the rectifier output until the desired value is obtained. The desired values are continuously maintained by this measurement and adjust cycle of the microcomputer 310.

The microcomputer 310 also stores the measured values of rectifier output voltage in an internal nonvolatile memory. These readings are stored at a predetermined interval (e.g., every hour, etc.) along with a time and date stamp of when the measurements were made. This data can be transmitted to the user computing device via the network interface 202 and communication network at any time (e.g., at a regularly scheduled interval, on-demand, etc.), as further described herein. In an embodiment, the rectifier controller 102 is connected to a cellular Internet modem (e.g., via network interface 202, an RS485 network, etc.) to allow remote control of the rectifier outputs as well as uploading the stored data for analysis and display, for example, by the user computing device.

In an embodiment, the rectifier controller 102 is used to remotely control the output of any TAP-type Cathodic Protection Rectifier (e.g., rectifier 104). The rectifier controller 102 is inserted between the AC power mains and the rectifier 104. The rectifier controller 102 reads the voltage and current output of the rectifier 104 and allows the operator to set the output of the rectifier between zero volts and the full scale output of the rectifier.

The operator controls the rectifier 104 in an embodiment by logging on to the rectifier controller 102 via a Wi-Fi connection, for example. Any Wi-Fi enabled laptop computer, tablet computer, and/or smartphone can be used to control the rectifier 104. The addition of a cellular and/or other type of Internet connection allows remote control of the rectifier 104 worldwide via the Internet. In an aspect, rectifier controller 102 enables display of parameters of rectifier 104 (e.g., rectifier output voltage, rectifier output current, potentials from standard cathodic protection (CP) reference electrodes, etc.) via a web page, as further described herein.

Exemplary Specifications:
Rectifier type: Any transformer type 120 VAC single phase rectifier;
Rectifier amps: 30 amps ac input maximum;
Rectifier DC voltage: 0-100 VDC 0.1 volt resolution;
Rectifier DC current: 0-80 ADC 0.1 amp resolution;
Maximum voltage output is limited to maximum level for the rectifier rating and TAP setting;
Current output is limited by 30 AMP maximum input current; and
The system can be contacted while on site by logging on to the system Wi-Fi or from any Internet-connected device worldwide.

Exemplary Installation Instructions:

a. Turn off breakers and disconnect the rectifier 104 from the AC power before attempting to connect the rectifier controller 102.

b. Connect the female 30 amp AC input power connector to the AC power mains as follows:
Line (e.g., line input 110) - - - black or clear connection
Neutral (e.g., neutral input 112) - - - white connection
Safety ground (e.g., ground input 114) - - - green connection

c. Connect the male 30 amp connector to the rectifier ac inputs as follows:
Line (e.g., line output 116) - - - black or clear connection
Neutral (e.g., neutral output 118) - - - white connection
Safety ground (e.g., ground output 120) - - - green connection

d. Connect the banana terminals labeled “shunt” on the rectifier controller 102 panel to an appropriate shunt installed in the positive (+) or anode output lead of the rectifier 104. The red terminal should be connected to the positive (+) side of the shunt and the black terminal should be connected to the negative (−) terminal of the shunt.

e. Connect the banana terminals labeled “rectifier output” on the rectifier controller 102 panel to the output leads of the rectifier 104. The red terminal should be connected to the positive (+) or anode output of the rectifier 104 and the black terminal should be connected to the negative (−) or structure output of the rectifier 104.

f. Connect a CP reference cell to one or both of the reference cell inputs located on the rectifier controller 102 panel. The reference cell is connected to the red terminal and the reference cell ground is connected to the black terminal. Note: the reference cell ground must be the same as the system negative or structure connection. Do not connect the reference cell ground to the anode connection or any independent ground connection. The red terminal should be connected to a silver chloride (Ag/Cl) or copper sulphate (CuSO4) reference electrode. In an embodiment, the maximum voltage on the reference cell terminals must not exceed 2.0 VDC.

g. Check all connections before applying power to the system. Be sure the 30 amp circuit breaker on the rectifier controller 102 front panel is in the OFF position before energizing the input power.

h. Install the Wi-Fi hotspot in an area that will allow reception of cellular signals. In an embodiment, the hotspot is installed within about 50 feet of the rectifier controller 102. The rectifier controller 102 and Wi-Fi hotspot should be in the same room or enclosure, for example. Enclosing the rectifier controller 102 or hotspot in a metallic enclosure may result in the controller being unable to receive the Wi-Fi signal.

i. Installation is complete.

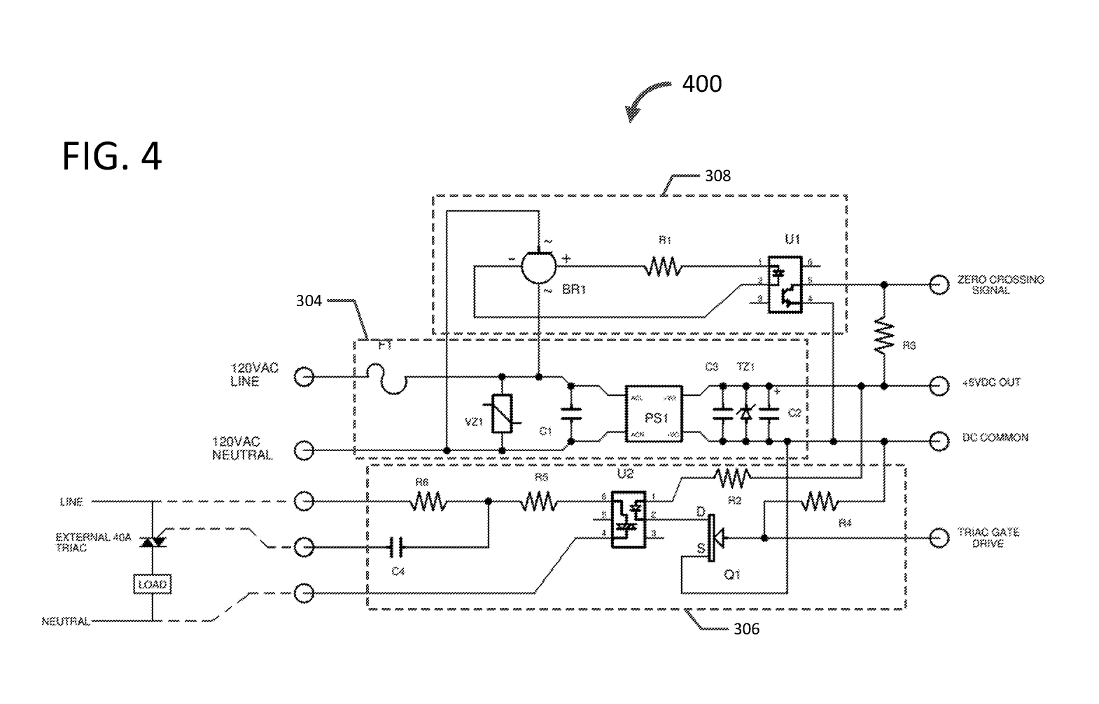

As shown in FIG. 4, a TRIAC embodies the semiconductor device 306. FIG. 4 is an exemplary schematic of a TRIAC driver board 400. In the illustrated embodiment, the TRIAC driver board 400 contains an isolated 120 VAC to 5 VDC power supply for all electronic power, the AC waveform zero-crossing detector (e.g., zero-crossing detector 308), and TRIAC driver circuitry for the rectifier controller 102. This board 400 is used in conjunction with the TAP CONTROLLER microcomputer 310 board to form the complete rectifier controller 102 in an embodiment.

The fuse F1, surge suppressor VZ1, power supply PS1, capacitors C1, C2, and C3, and Zener diode TZ1 in the illustrated embodiment form the isolated 120 VAC to 5 VDC power supply (e.g., power supply 304) for all electronic circuitry. The metal-oxide varistor (MOV) surge suppressor circuit (VZ1) is configured to protect following circuitry from AC noise. The capacitors (C1, C2, C3) are smoothing capacitors and the Zener diode (TZ1) is configured to provide over-voltage protection for the electronic circuitry. The power supply (PS1) is an isolated 102 VAC to 5 VDC converter module.

Referring further to the illustrated embodiment, the bridge rectifier BR1, resistor R1, and phase detector circuit U1 form the zero-crossing detector 308 for the microcomputer 310. The zero-crossing detector 308 circuit provides (e.g., outputs) an isolated 5 Volt pulse whenever the input AC waveform crosses zero. This is used as the basis for the phase control timing of rectifier controller 102.

The transistor Q1, thyristor circuit U2, and associated resistors and capacitors form the isolated drive circuit (e.g., the TRIAC embodying semiconductor device 306) for an external 40 volt power TRIAC. An exemplary external TRIAC includes the Qxx40xx Series 40 Amp Alternistor (High Communication) Teccor® brand TRIACs available from Littelfuse, Inc.

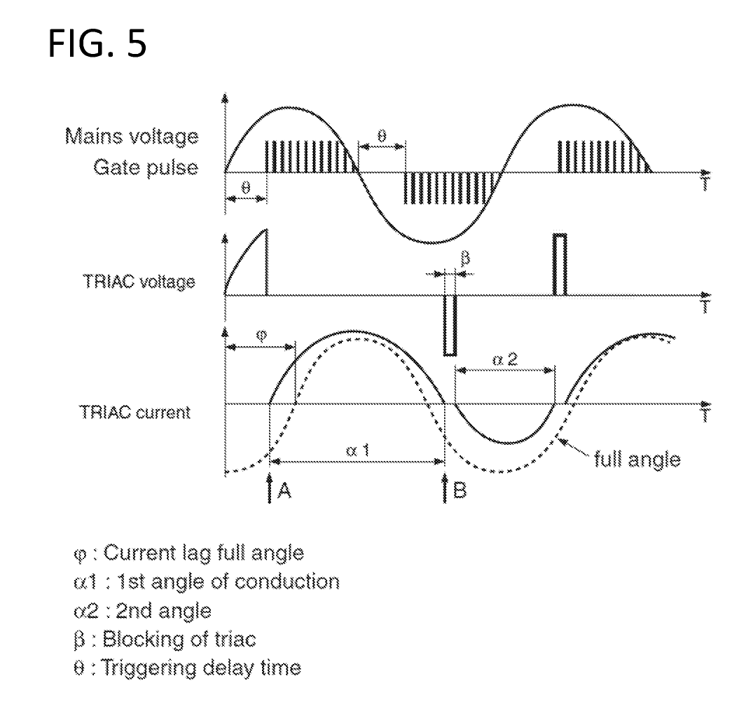

FIG. 5 illustrates an exemplary triggering by pulse train synchronization of rectifier controller 102 through the use of semiconductor device 306. In an embodiment, semiconductor device 306 maintains the triggering signal during each half wave between values θ and 180°. This is accomplished by sending a pulse train after the initial pulse so as to maintain the triggering order, as shown in FIG. 5.

For example, suppose that angle φ is equal to 85° and θ is equal to 60°. At the first pulse, semiconductor device 306 is turned ON at point A (60°). It conducts for angle α1 greater than 180° and close to 240°. It is blocked at point B, but is immediately triggered at point B′ by the next gate pulse. During the first half-waves, operation is slightly asymmetrical but gradually the durations of conduction become balanced (refer to the dotted line curve in FIG. 5).

In an embodiment, a small sensitive auxiliary TRIAC (Ts) is used to produce the required pulse train. The delay time constant, which is defined by a capacitor (C), a compensating resistor (Rt), and a potentiometer (P), sets the angle θ. The capacitor charges from 0 V. A Diode Alternating Current (DIAC) (D) triggers the TRIAC (T) as soon as the capacitor voltage reaches the DIAC breakover voltage (Vbo). This time is the same for both half-waves; it depends on Vbo symmetry. A first pulse is applied to the gate of the main TRIAC (T). A voltage pulse occurs across a resistor (Rd) and triggers the sensitive TRIAC (Ts). Once turned on, this TRIAC (Ts) bypasses potentiometer (P). Thus, the remaining charging cycles of the capacitor have a much shorter time constant (e.g., Rt C).

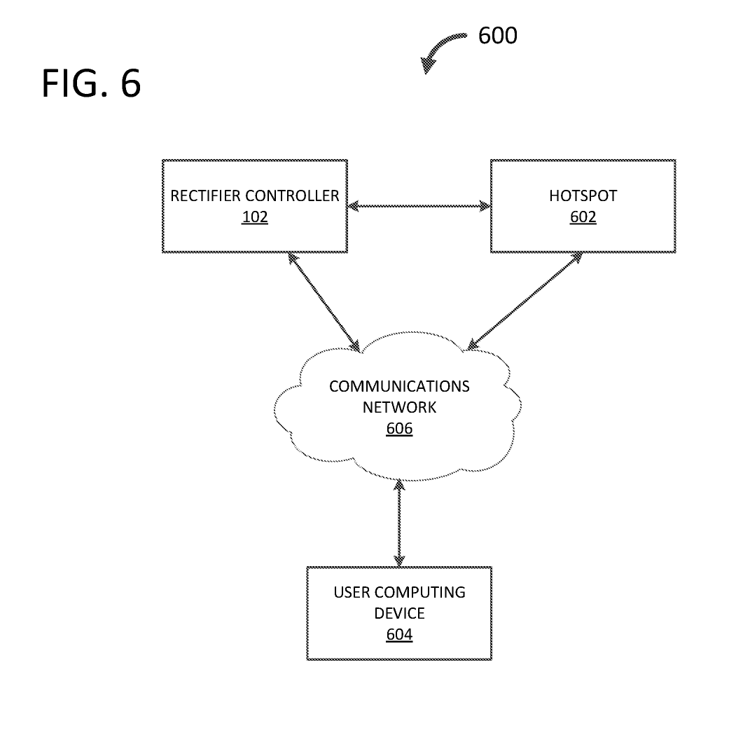

FIG. 6 illustrates an exemplary system, generally indicated at 600, in accordance with an aspect of the present disclosure that includes rectifier controller 102, a hotspot 602, and a user computing device 604 that are each communicatively coupled via a communications network 606. In an embodiment, rectifier controller 102 is communicatively coupled to the user computing device 606 via network interface 202 and communications network 606. In another embodiment, rectifier controller 102 is communicatively coupled to the user computing device 606 via network interface 202, hotspot 602, and communications network 606. Exemplary computing devices include, but are not limited to, personal computers (PCs), desktop computers, laptop computers, tablet computing devices, smartphones, one or more server computers, and the like, and/or combinations thereof.

The communications network 606 is capable of facilitating the exchange of data among the devices that comprise the exemplary system 600. The communications network 606 in the embodiment of FIG. 6 includes a wide area network (WAN) that is connectable to other telecommunications networks, including other WANs, local area networks (LANs), or portions of the Internet or an intranet. The communications network 606 may be any telecommunications network that facilitates the exchange of data, such as those that operate according to the IEEE 802.3 (e.g., Ethernet) and/or the IEEE 802.11 (e.g., Wi-Fi) protocols, for example. In another embodiment, communications network 606 is any medium that allows data to be physically transferred through serial or parallel communication channels (e.g., copper wire, optical fiber, computer bus, wireless communication channel, etc.).

Although the embodiment of system 600 illustrated in FIG. 6 includes one rectifier controller 102, one hotspot 602, and one user computing device 604, one having ordinary skill in the art will understand the system 600 may include a plurality of one or more of rectifier controller 102, hotspot 602, and user computing device 604. For example, a single user computing device 604 may be communicatively coupled to a plurality of rectifier controllers 102. The plurality of rectifier controllers 102 may connect to a single hotspot 602, each rectifier controller 102 may have a corresponding hotspot 602, or any combination thereof. In another non-limiting example, a plurality of user computing devices 604 may be communicatively coupled to a single rectifier controller 102. In yet another non-limiting example, a plurality of user computing devices 604 may be communicatively coupled to a plurality of rectifier controllers 102.

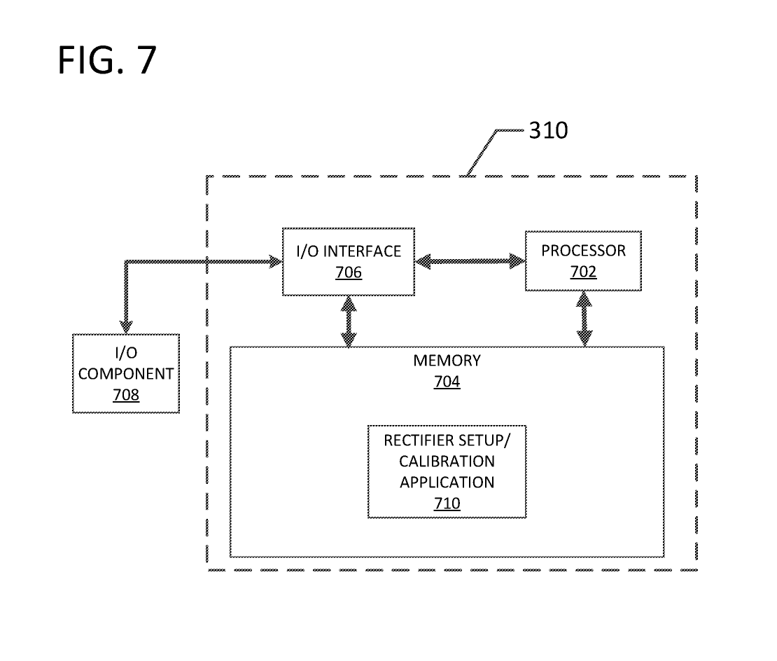

FIG. 7 illustrates an exemplary architecture of microcomputer 310 programmed to provide aspects of the systems and processes described herein via a software environment. In the embodiment of FIG. 7, the microcomputer 310 includes a processor 702, a memory 704, and an input/output (I/O) interface 706 that interfaces with an I/O component 708. The memory 704 includes a rectifier setup and calibration application 710 embodied in processor-executable instructions for executing by processor 702. In this manner, microcomputer 310 comprises a special-purpose computing device for initialization (e.g., setup and/or calibration) of rectifier controllers (e.g., rectifier controller 102) in accordance with an aspect of the disclosure.

The processor 702, memory 704, and I/O interface 706 are communicatively connected and/or electrically connected to each other. The I/O interface 706 is communicatively and/or electrically connected to the I/O component 708. The processor 702 is adapted to execute processor-executable instructions stored in the memory 704 for setting up and/or calibrating rectifier controller 102. The I/O interface 706 of FIG. 7 provides a physical data connection between the microcomputer 310 and I/O component 708. In an embodiment, I/O interface 706 is one or more data pins and I/O component 708 is network driver 320, network interface 202, communications network 606, or combinations thereof.

In an embodiment, connecting to the rectifier controller 102 requires a Wi-Fi enabled laptop computer, tablet computer, or smartphone. While in the vicinity of the hotspot it is best to log on to the hotspot directly. To log on to the hotspot, the user navigates to a Wi-Fi setup page or a program on the user's computing device. One of ordinary skill in the art will understand how to connect the computing device to a Wi-Fi hotspot and use the browser, for example, logging on to the hotspot using a service set identifier (SSID) and password. Upon connecting to the hotspot, the user opens a browser on the computing device and navigates to the address of the rectifier controller 102 (e.g., http://192.168.0.100:7780) and a controller web page (not shown) appears. In an embodiment, the user sees the INP VOLTS column and ENG VALUES slowly change. NOTE: These values will not be accurate until the system has been calibrated.

To connect to the system when not on site, the user navigates to the following exemplary Internet address to contact the system: http://166.166.245.37:7780. Operation is identical in either connection, and the Internet connection can be used while on site if desired.

In an embodiment, the web page (not shown) provides the data names, calibration data, and output values for each of the 4 channels measured. For example, each line shows the values for the output as follows:

LINE 1: Rectifier Volts. The rectifier output voltage in DC VOLTS

LINE 2: Rectifier AMPS. The rectifier output current in DC AMPS.

LINE 3: POT1: Reference cell 1 voltage.

LINE 4: POT4: Reference cell 2 voltage.

Further to the example, columns are defined as follows:

Column 1: NAME—The name of the channel.

Column 2: INP LOW—The low input voltage for calibration.

Column 3: INP HIGH—The high input voltage for calibration.

Column 4: ENG LOW—The low engineering value for calibration.

Column 5: ENG HIGH—The high engineering value for calibration.

Column 6: RNG—The input range. Always 0.

Column 7: INP VOLTS—The raw input data as measured by the system.

Column 8: ENG VALUE—The actual Output Voltage, Current, and Potentials after applying the calibration.

The buttons in the present example are defined as follows:

SAVE: Saves the Calibration values to permanent memory (e.g., memory 704, etc.).

RELOAD: Causes the new calibration values to be used to calculate ENG output.

SET OUTPUT: Set the output of the rectifier.

Since the full scale value of each rectifier and TAP setting is different, it is necessary to set the output voltage as a percentage of full scale. When the SET OUTPUT button is selected (e.g., clicked, tapped, etc.), the system will ask for the output percentage value. Allowable values are 1-100%. Setting the output to 1% turns the output OFF. Setting the output to 100% sets the output to the maximum voltage and current the rectifier can produce at the current TAP settings.

Because each rectifier will have different maximum values of output voltage and current, as well as the unfiltered DC output of these rectifiers, the controller is preferably calibrated for each rectifier before operation. Once the calibration values have been entered and saved, it should not be necessary to recalibrate unless the system is moved to a different rectifier or the TAP setting are changed. A digital voltmeter is utilized to calibrate and test the controller.

In an embodiment, the Voltage and Current channels are calibrated before operating the controller the first time. The following describes an exemplary process for calibrating the output voltage:
1. Connect the digital multimeter to the rectifier output terminals. All of the instructions below are entered on the first “Rectifier VOLTS” line of the display.
2. Select the ‘SET OUTPUT’ button on the web page.
3. Enter a value of 2%.
4. Monitor the reading on the voltmeter and the ‘INP VOLTS’ on the web page until both are stable and show little change.
5. Select the ‘INP LOW’ button on the rectifier volts line. Enter the value shown in the ‘INP. VALUE’ column in the pop up box.
6. Select the ‘ENG LOW’ button on the rectifier volts line. Enter the value shown on the voltmeter in the pop up box.
7. Select the ‘SAVE’ button.
8. When the screen reappears, wait a few seconds and select the ‘RELOAD’ button. Allow several seconds for the output to stabilize.
9. Select the ‘SET OUTPUT’ button on the web page.
10. Enter a value between 60-90%.
11. Monitor the reading on the voltmeter and the ‘INP VOLTS’ on the web page until both are stable and show little change.
12. Select the ‘INP HIGH’ button on the rectifier volts line. Enter the value shown in the ‘INP VALUE’ column in the pop up box.
13. Select the ‘ENG HIGH’ button on the rectifier volts line. Enter the value shown on the voltmeter in the pop up box.
14. Select the ‘SAVE’ button.
15. When the screen reappears, wait a few seconds and select the ‘RELOAD’ button. Allow several second for the output to stabilize.
16. Select the ‘SET OUTPUT’ button on the web page.
17. Enter a value of 40%.
18. Monitor the ‘ENG VALUE’ box and compare to the voltmeter reading. It may take several seconds for the new settings to stabilize. Allow 60-90 seconds. The value shown in the ‘ENG VALUE’ box should correspond to the multimeter readings within a few counts.
19. Try setting the output to different values and compare reading shown in ‘ENG VALUE’ box to voltmeter reading. If the reading is not stable or is inaccurate, try the calibration procedure again. Lower the high value percentage by 10%.

The following describes an exemplary process for calibrating the output current:

1. Connect the digital multimeter to the shunt terminals. All of the instructions below are entered on the second “rectifier amps” line of the display.
2. Select the ‘SET OUTPUT’ button on the web page.
3. Enter a value of 2%.
4. Monitor the reading on the voltmeter and the ‘INP VOLTS’ on the web page until both are stable and show little change.
5. Select the ‘INP LOW’ button on the rectifier amps line. Enter the value shown in the ‘INP VALUE’ column in the pop up box. Do not convert this reading to amps. Enter the voltage value shown.
6. Select the ‘ENG LOW’ button on the rectifier amps line. Convert the value shown on the voltmeter to amps and enter in the pop up box.
7. Select the ‘SAVE’ button.
8. When the screen reappears, wait a few seconds and select the ‘RELOAD’ button. Allow several seconds for the output to stabilize.
9. Select the ‘SET OUTPUT’ button on the web page.
10. Enter a value between 60-90%.
11. Monitor the reading on the voltmeter and the ‘INP AMPS’ on the web page until both are stable and show little change.
12. Select the ‘INP HIGH’ button on the rectifier amps line. Enter the value shown in the ‘INP VALUE’ column in the pop up box. Do not convert this reading to amps. Enter the voltage value shown.
13. Click the ‘ENG HIGH’ button on the rectifier volts line. Convert the value shown on the voltmeter to amps and enter in the pop up box.
14. Click the ‘SAVE’ button.
15. When the screen reappears, wait a few seconds and select the ‘RELOAD’ button. Allow several second for the output to stabilize.
16. Select the ‘SET OUTPUT’ button on the web page.
17. Enter a value of 40%.
18. Monitor the ‘ENG VALUE’ box and compare to the voltmeter reading after converting the shunt voltage to amps. It may take several seconds for the new settings to stabilize. Allow 60-90 seconds. The value shown in the ‘ENG VALUE’ box should correspond to the multimeter readings, converted to amps, within a few counts.
19. Try setting the output to different values and compare reading shown in ‘ENG VALUE’ box to voltmeter reading, converted to amps. If the reading is not stable or is inaccurate, try the calibration procedure again. Lower the high value percentage by 10%.

Note: in the above steps, it will be necessary to convert the voltage reading across the shunt to amps before entering into the system. Do not enter the voltage value shown on your digital voltmeter in to the ENG VALUE box. This applies when entering ENG values.

Note: best results will be achieved if the tap settings on the rectifier are set to the lowest setting that will provide the necessary voltage and current for the application. The low output settings for calibration can range from 2%-5% and the high setting can range from 60%-90%. Do not use output values outside of this range for calibration. The calibration will be accurate for the entire output range regardless of the values used for calibration.

Output values of less than 5% may be inaccurate and unstable. If the user need outputs in this range, lower the tap setting to the lowest value that will provide the maximum voltage and current output for your installation.

In addition to the embodiments described above, embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer and comprises computer storage media and communication media. By way of example, and not limitation, computer storage media include both volatile and nonvolatile, removable and non-removable media implemented in any method or technology for storage of information such as computer-readable instructions, data structures, program modules or other data. Computer storage media are non-transitory and include, but are not limited to, random access memory (RAM), read-only memory (ROM), electrically erasable programmable ROM (EEPROM), compact disk ROM (CD-ROM), digital versatile disks (DVD), or other optical disk storage, solid state drives (SSDs), magnetic cassettes, magnetic tape, magnetic disk storage, or other magnetic storage devices, or any other medium that can be used to carry or store desired non-transitory information in the form of computer-executable instructions or data structures and that can be accessed by a computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory computer storage media, including nonvolatile and volatile memory types. A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer-readable media for storing data can be used, including magnetic cassettes, flash memory cards, digital video disks, Bernoulli cartridges, RAMs, ROMs, SSDs, and the like.

Communication media typically embody computer-readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter. In addition to the monitor, personal computers typically include other peripheral output devices (not shown), such as speakers and printers.

One or more aspects of the disclosure may be embodied in computer-executable instructions (i.e., software), routines, or functions stored in system memory or nonvolatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer-executable instructions may be stored on one or more tangible, non-transitory computer-readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A controller for a cathodic protection rectifier, comprising:
a triode for alternating current (TRIAC) electrically coupled to an alternating current (AC) electric power input, the TRIAC configured to switch into and out of conduction in response to a trigger signal at a predetermined phase of AC electrical power received from the AC electric power input to control a phase angle of the AC electrical power; and
an electric power output electrically coupled to the TRIAC, the electric power output configured to electrically connect to an input of the cathodic protection rectifier and provide the phase angle controlled AC electrical power from the TRIAC thereto,
wherein the switching into and out of conduction by the TRIAC causes at least one of a voltage output of the cathodic protection rectifier and a current output of the cathodic protection rectifier to vary continuously from zero to a full-scale output thereof as a function of the controlled phase angle of the AC electrical power.

2. The controller of claim 1, further comprising a transformer electrically coupled to the AC electric power input, the transformer configured to provide a reference signal for zero-crossing detection.

3. The controller of claim 2, further comprising an AC to DC power supply electrically connected to the transformer, the AC to DC power supply configured to transform the received AC electrical power into direct current (DC) electrical power.

4. The controller of claim 2, further comprising a zero-crossing detector electrically coupled to the transformer, the zero-crossing detector configured to detect when a waveform of the received AC electrical power crosses zero on a voltage axis based on a zero-crossing reference signal.

5. The controller of claim 4, further comprising a microcomputer configured to generate the trigger signal to control the switching into and out of conduction by the TRIAC as a function of the zero-crossing reference signal.

6. The controller of claim 5, wherein the microcomputer is communicatively coupled to the zero-crossing detector, wherein the microcomputer receives a pulse from the zero-crossing detector upon detecting when the waveform of the received AC electrical power crosses zero on the voltage axis, and wherein reception of the pulse begins a timing delay before generating the trigger signal to switch the TRIAC into conduction.

7. The controller of claim 5, wherein the microcomputer includes a memory and is configured to log values of at least one of a shunt output of the cathodic protection rectifier and a voltage output of the cathodic protection rectifier in the memory.

8. The controller of claim 1, further comprising:
a first isolated amplifier;
a second isolated amplifier;
a first low-pass filter; and
a second low-pass filter,
wherein an input of the first isolated amplifier is configured to electrically connect to a shunt output of the rectifier,
wherein an output of the first isolated amplifier is electrically coupled to an input of the first low-pass filter,
wherein an output of the first low-pass filter is electrically coupled to the microcomputer for logging the values of the shunt output of the cathodic protection rectifier,
wherein an input of the second isolated amplifier is configured to electrically connect to the voltage output of the cathodic protection rectifier,
wherein an output of the second isolated amplifier is electrically coupled to an input of the second low-pass filter, and
wherein an output of the second low-pass filter is electrically coupled to a microcomputer for logging the values of the voltage output of the cathodic protection rectifier.

9. The controller of claim 8, wherein the first isolated amplifier is configured to electrically connect to the shunt output of the cathodic protection rectifier via a four-conductor sensor cable, and wherein the second isolated amplifier is configured to electrically connect to the voltage output of the cathodic protection rectifier via the four-conductor sensor cable.

10. The controller of claim 1, further comprising a microcomputer is configured to receive control signals from a user computing device via a communications network, wherein the control signals initialize the microcomputer for controlling the conduction modulation of the TRIAC.

11. The controller of claim 10, further comprising a network driver and a network interface configured to communicatively couple the microcomputer to the communications network.

12. The controller of claim 11, wherein the microcomputer is configured to serve a web page of a setup or calibration application to a user computing device via the network driver, the network interface, and the communications network.

13. A method of controlling a rectifier, comprising:
receiving alternating current (AC) electrical power from an electric power supply;
receiving a trigger signal from a microcomputer;
controlling a phase angle of the received AC electrical power by switching a solid-state semiconductor device into and out of conduction in response to receiving the trigger signal at a predetermined phase of the received AC electrical power; and
providing the phase angle controlled AC electrical power via the switched semiconductor device to an input of a cathodic protection rectifier,
wherein said switching the semiconductor device into and out of conduction causes at least one of a voltage output of the cathodic protection rectifier and a current output of the cathodic protection rectifier to vary continuously from zero to a full-scale output thereof based on the controlled phase angle of the AC electrical power.

14. The method of claim 13, further comprising logging values of at least one of a shunt output of the cathodic protection rectifier and a voltage output of the cathodic protection rectifier in a memory device.

15. The method of claim 14, further comprising providing the logged values of the shunt output of the cathodic protection rectifier or the voltage output of the cathodic protection rectifier to a user computing device.

16. The method of claim 13, further comprising receiving control signals from a user computing device, wherein the control signals initialize the microcomputer to perform the controlling.

17. The method of claim 13, further comprising serving a web page of a setup or calibration application to a user computing device for initializing the microcomputer to perform the controlling.

18. The method of claim 13, further comprising:
detecting when a waveform of the received AC electrical power crosses zero on a voltage axis based on a zero-crossing reference signal; and
generating the trigger signal to control the switching into and out of conduction by the semiconductor device as a function of the zero-crossing reference signal.

19. The method of claim 18, further comprising:
receiving a pulse from a zero-crossing detector upon detecting when the waveform of the received AC electrical power crosses zero on the voltage axis; and
in response to the pulse, beginning a timing delay before generating the trigger signal to switch the semiconductor device into conduction.

20. A system, comprising:
one or more user computing devices;
a communications network; and
at least one controller, the controller comprising:
a triode for alternating current (TRIAC) electrically coupled to an alternating current (AC) electric power input, the TRIAC configured to switch into and out of conduction in response to a trigger signal at a predetermined phase of AC electrical power received from the AC electric power input to control a phase angle of the AC electrical power; and
an electric power output electrically coupled to the TRIAC, the electric power output configured to electrically connect to an input of the cathodic protection rectifier and provide the phase angle controlled AC electrical power from the TRIAC thereto,
wherein the switching into and out of conduction by the TRIAC causes at least one of a voltage output of the cathodic protection rectifier and a current output of the cathodic protection rectifier to vary continuously from zero to a full-scale output thereof as a function of the controlled phase angle of the AC electrical power;
wherein the one or more user computing devices are communicatively coupled to the at least one controller via the communications network.
